(19) United States
(12) Patent Application Publication
(10) Pub. No.: US 2013/0102717 A1
(43) Pub. Date: Apr. 25, 2013

(54) ORIENTATION MODIFIER FOR BRIGHTENING PIGMENT

(71) Applicants: Tsukasa Akutagawa, Nara-shi (JP); Masahiro Takagi, Nara-shi (JP); Daisuke Mitomi, Nara-shi (JP); Takanori Matsuyama, Nara-shi (JP)

(72) Inventors: Tsukasa Akutagawa, Nara-shi (JP); Masahiro Takagi, Nara-shi (JP); Daisuke Mitomi, Nara-shi (JP); Takanori Matsuyama, Nara-shi (JP)

(73) Assignee: KYOEISHA CHEMICAL CO., LTD., Osaka-shi, Osaka (JP)

(21) Appl. No.: 13/806,963

(22) PCT Filed: Jun. 1, 2011
(86) PCT No.: PCT/JP2011/062589

§ 371 Date: Dec. 26, 2012

(30) Foreign Application Priority Data
Jun. 28, 2010 (JP) 2010-145828

(51) Int. Cl. C09D 5/00

(52) U.S. Cl. CPC C09D 5/00
USPC 524/325; 525/327.7; 524/549; 524/437; 524/413; 524/435; 524/430

(57) ABSTRACT

Provided is a low-cost orientation modifier that is added to paint containing a brightening pigment to adequately disperse the brightening pigment. The orientation modifier for the brightening pigment is obtained through the esterification of: an α-olefin/maleic anhydride copolymer formed by the coplymerization of a linear or branched α-olefin with at least 6 carbons and a maleic anhydride; and a polyethylene glycol monoalkyl ether represented by R¹—(OCH₂CH₂)ₙ—OH (in the formula, R¹ is a linear or branched alkyl group with 6-30 carbons, and n is a number from 5 to 60), and having a hydrophilic-lipophilic balance of 9 to 19. The orientation modifier contains an ester compound having an acid value of 15 to 60 mg.KOH/g.

### TECHNICAL FIELD

The present invention relate to an orientation modifier which is used for improving an orientation property of a brightening pigment in an orientation paint film, whose color varies when viewed from different angles, formed on exteriors of car bodies, housings of home appliances, plastic products, etc. by applying a brightening pigment-coating orientation paint.

### BACKGROUND ART

The surfaces of exteriors of car bodies, housings of home appliances such as cell-phones, daily use plastic products, etc., are often painted in a metallic finish with excellent designs and gorgeous decorations based on the trends and the aesthetic preferences of consumers. For such paint films, paints containing a brightening pigment such as an aluminum flake pigment, etc. having an orientation property of so-called flip-flop effect in which the color of the paint film when the paint film is observed from the front, is different from the color of the same paint film when observed from an oblique direction, are used widely.

In order to develop the orientation of the brightening pigment in the paint film formed by applying the paint, a dispersant which homogeneously disperses the brightening pigment is previously added into the paint. As a paint including thus dispersant, Patent document 1 described below discloses that an ink composition comprises a wax or resin, a pigment dispersant comprising an ester modified copolymer having a saponification value of 100 KOH.mg/g or less, which is produced by esterification of a copolymer produced from a-olefin and maleic anhydride with a monohydric alcohol such as an aliphatic alcohol or an aromatic alcohol having a carbon number of 6-60, and pigment. Patent Document 2 described below discloses a method for producing a resin by reacting one or more kinds selected from a hydroxyl acid, an amino acid and a nonionic emulsifier with a copolymer of an a-olefin having a carbon number of 6 or more and maleic anhydride. Patent Document 3 described below discloses a brightening paint composition comprising a vehicle, a brightening pigment and an acidic pigment dispersant having a total acid amount of 500-1,500 μmol/g.

Based on the trends of market and aesthetic preferences of consumers, desired are versatile orientation modifiers to be added into paints containing a brightening pigment in order to adequately disperse the brightening pigment which have the ability to cause a paint film, which is formed by applying the paint, to further improve the flip-flop effect of the brightening pigment in which the surface of the paint film clearly exhibits a dense, strongly shiny, light-colored white highlight when the paint film is observed from the front and the same surface exhibits a smoky dark-colored black shade with suppressed luster when observed from an oblique direction; and a brightening pigment-containing paint which contains the orientation modifier.

### PRIOR ART DOCUMENTS

### Patent Documents

Patent Document 1: Japanese Unexamined Patent Application Publication No. 01-261474A

Patent Document 2: Japanese Unexamined Patent Application Publication No. 04-089808A

Patent Document 3; Japanese Unexamined Patent Application Publication No. 2002-285093A

### SUMMARY OF INVENTION

### Problems to be Solved by the Invention

The present invention was provided to solve the aforementioned problems, and to provide a low cost versatile orientation modifier, that can be easily manufactured, that is to be added to a paint which contains a brightening pigment in order to sufficiently disperse the brightening pigment, and that has the ability to cause a paint film which is formed by applying the paint to further improve the flip-flop effect of the brightening pigment. Also the present invention is to provide an orientation paint that contains the orientation modifier and the brightening pigment.

### Means to Solve the Problems

An orientation modifier for a brightening pigment of the present invention comprises:
an ester compound having an acid value of 15-60 mg.KOH/g, which is esterified between:
   an a-olefin/maleic anhydride copolymer copolymerized from a linear or branched a-olefin having at least 6 carbon atoms and a maleic anhydride; and
   a polyethylene glycol monoalkyl ether having a hydrophile-lipophile balance of 9-19, which is represented by the following chemical formula (1)

R¹—(OCH₂CH₂)ₙ—OH (1)

(in the formula (1), R¹ is a linear or a branched alkyl group having a carbon number of 6-30, and n is a number of 5-60).

A brightening pigment-containing orientation paint of the present invention comprises:

0.01-5% by weight of the ester compound in the orientation modifier for the brightening pigment according to Claim 1, wherein the weight is based on the total weight;

1-50% by weight of the brightening pigment which is dispersed by the orientation modifier; and

10-95% by weight of a vehicle.

The brightening pigment-containing orientation paint of the present invention, wherein the brightening pigment is a flaky pigment of aluminum flake pigment, titanium flake pigment, stainless steel flake pigment, colored aluminum pigment, metal oxide-coated mica pigment, metal oxide-coated silica flake pigment, metal oxide-coated aluminum flake pigment, metal oxide-coated glass flake pigment, plate-like iron oxide pigment and/or a flake-like pigment made of cholesteric liquid crystal polymer.

A cured orientation paint film of the present invention comprising: the brightening pigment-containing orientation paint according to Claim 2 or 3, wherein the paint is applied on a base material to be cured.

### Effect of the Invention

The orientation modifier for brightening pigment of the present invention can fully disperse the brightening pigment by adding the orientation modifier to the brightening pigment-containing paint, and is versatile and easily manufactured at low cost through a simple process.

The brightening pigment-containing orientation paint of the present invention, that contains the orientation modifier and brightening pigment, can be applied and cured on a base material to form a paint film, develops a further improved flip-flop effect when compared to a conventional dispersing agent-containing orientation paint. Therefore, the paint film clearly exhibits a dense, strongly shiny, light-colored white highlight with strong luster when the paint film is observed from the front, and the same surface exhibits a smoky dark-colored black shade with suppressed luster when observed from an oblique direction; being excellent in design.

This orientation modifier does not degrade properties of curing ingredients, pigments and dyes in the paint, therefore, the paint film has high hardness and has an excellent anti abrasive property. The paint film also has an excellent weatherability and heat resistance.

### MODE FOR CARRYING OUT THE INVENTION

Preferred embodiment of the present invention will be precisely described below, but the scope of the present invention should not be limited to these embodiments.

The orientation modifier of the present invention comprises an ester compound which is produced through a ring-opening addition reaction between a terminal hydroxyl group of polyethylene glycol monoalkyl ether represented by the following chemical formula described below

R¹—(OCH₂CH₂)ₙ—OH

(in the formula, R¹ is a linear or branched alkyl group having a carbon number of 6-30, n is 5-60)
and a maleic anhydride group of an a-olefin/maleic anhydride copolymer which is obtained through copolymerization between maleic anhydride and a linear or branched a-olefin having a carbon number of 6 or more such as 1-dodecene, 1-tetradecene, etc.

The ester compound having a preferable acid value of 15-60 mg.KOH/g can be obtained under the control at a reaction temperature of 100° C.-250° C. for 1 hour-8 hours. The ester compound may be a single substance or a mixture of 2 or more.

With the assistance of the presence of the ester compound, the orientation modifier develops an excellent dispersibility of the brightening pigment and orientation thereof, which also causes an excellent flip-flop effect. This orientation modifier significantly improves dispersibility and orientation of the brightening pigment when compared to conventional acidic dispersants. The possible working mechanism of this orientation modifier may be as follows.

The a-olefin/maleic anhydride copolymer of the ester composition may be alternately and sequentially copolymerized through charge-transfer complex reaction between an unsaturated terminal group of the a-olefin and an unsaturated group of a maleic anhydride which is hard to homopolymerize, so that the obtained copolymer is an alternate copolymer having a linear main chain as the copolymerized main chain.

In the ester compound produced by reacting the a-olefin/maleic anhydride copolymer as the alternate copolymer with polyethylene glycol monoalkyl ether, alignment of a hydrophobic site such as a hydrocarbon group derived from the a-olefin and a hydrophilic site such as a carboxyl group formed when maleic anhydride group derived from maleic anhydride is subjected to a ring opening reaction, is controlled and the hydrophobic site and the hydrophilic site are aligned alternately with each other. Following mechanism can be assumed. Due to the regular alternating copolymerization structure of the a-olefin/maleic anhydride copolymer, the brightening pigment may be efficiently adsorbed to the interface of the main chain of the copolymer of the a-olefin and maleic anhydride when compared to a random copolymer such as a copolymer made of an a-olefin and an acrylic compound. Accordingly, the orientation modifier of the present invention may help substantially improve the dispersibility of the brightening pigment.

Further, in this ester compound, the terminal alkyl group having a comparatively-hydrophobic property, that is derived from the polyethylene glycol monoalkyl ether, is located, by way of a comparatively-hydrophilic polyethylene glycol group, at a place widely separated from the copolymer's hydrophobic main chain; on the other hand, a hydrophobic hydrocarbon group, that is derived from the a-olefin, is branched from the copolymer's hydrophobic main chain and also directly connected to the copolymer's hydrophobic main chain. That is to say, the ester compound has different branched structures each having different properties. Following reasons can be assumed. This ester compound has two hydrophobic groups: one is the terminal alkyl group that is derived from polyethylene glycol monoalkyl ether which is widely separated from the copolymer's main chain; and another one is the hydrocarbon group that is derived from the a-olefin which is located near the copolymer's main chain. When compared to a polyester element of the polyether that has no hydrophobic group, these two hydrophobic groups may work as adsorbing sites for the brightening pigment. Therefore, a steric hindrance effect may be greatly increased, and the flip-flop effect or an orientation property of the brightening pigment may be greatly improved.

The a-olefin, that constitutes the ester compound, is not particularly limited, as long as it is a linear or branched unsaturated hydrocarbon having a carbon number of 6 or more, more preferably carbon number of 6-30. For example, 1-dodecene, 1-tetradecene and the mixture of them can be exemplified.

As the maleic anhydride that constitutes the ester compound, unsubstituted maleic anhydride, bromo maleic anhydride, etc. can be exemplified.

In polyethylene glycol monoalkyl ether that is represented by the following formula

R¹—(OCH₂CH₂)ₙ—OH,

that constitutes the ester compound, when the carbon number of the alkyl group R¹ is less than 6, adsorbing ability of the ester compound for the brightening pigment decreases. On the contrary, when the carbon number of the alkyl group R¹ exceeds 30, the cohesive force of the ester compound becomes too strong, so that solubility and dispersibility of the ester compound in the paint become low and the paint film exhibits unevenness. When n in the above chemical formula is less than 5, the terminal alkyl group which is derived from the polyethylene glycol monoalkyl ether becomes too close to the copolymer's main chain, on the other hand, when n exceeds 60, the terminal alkyl group locates too far away from the copolymer's main chain. In any way, effects on the surface of the brightening pigment become too small, so that sufficient dispersibility and orientation cannot be expected.

For Example, hydrophil-lipophile balance (HLB) of the polyethylene glycol monoalkyl ether is preferably in the range of 9-19, when measured by the Griffin method.

The orientation modifier can consist only of the ester compound, but can include medium, if necessary.

The brightening pigment-containing orientation paint comprises: paint ingredients of 0.01-5% by weight (based on the weight ratio to the paint) of the ester compound which exists in the orientation modifier for the brightening pigment,
1-50% by weight of the brightening pigment which is dispersed by the orientation modifier for the brightening pigment and exhibits the flip-flop effect, and
10-95% by weight of a vehicle; and
   other paint ingredients of additives if necessary.

When the amount of the brightening pigment is less than 1% by weight, the brightening effect is not fully observed. On the other hand, when the amount of the brightening pigment exceeds 50% by weight, the appearance of the paint film becomes poor. Preferable amount thereof is in the range of 5-30% by weight.

As the brightening pigment, scaly flake pigments having an average particle size of several dozen μm, more specifically, 10-30 μm, such as, for example, scaly metal-flake pigments such as aluminum flake pigments, titanium flake pigments, stainless flake pigments etc.; colored aluminum pigments covered by organic or inorganic colored pigments; metal oxide-covered mica pigments produced by covering the surface of a low refractive index with a metal oxide having a high refractive index such as titanium oxide, iron oxide, silica, alumina, zirconia, etc.; metal oxide-covered silica flake pigments produced by covering the surface of the silica flake with the metal oxide described above; metal oxide-covered alumina flake pigments produced by covering the surface of the alumina flake with the metal oxide described above; metal oxide-covered glass flake pigments produced by covering the glass flake surface with the metal oxide described above; plate-like iron oxide pigments; cholesteric liquid crystal polymer; etc. can be exemplified.

The vehicle contained in the brightening pigment-containing orientation paint has an effect to disperse the brightening pigment, and comprises a paint film-forming resin, if necessary a cross-linking agent and a solvent. As the paint film-forming resin which constitutes the vehicle, for example, acrylic resin, polyester resin, alkyd resin, fluorine-contained resin, epoxy resin, polyurethane resin, polyether resin, etc. can be exemplified. In particular, acrylic resin and polyester resin are preferably used. These paint film-forming resins can be used solely or in combination of 2 or more. As the paint film-forming resin, there are two types of resin. One is a curing type resin, and the other is a none-curing type resin that can be diluted to obtain a lacquer. The curing-type resins are widely used. The curing-type resins are used together with a cross-linking agent such as an amino resin, (block) polyisocyanate compound, amine series, polyamide series, polycarboxylic acids, etc. The paint film can be formed by curing reaction which is induced by heating or at a room temperature. On the other hand, the non-curing type paint film-forming resin can be used together with the curing type resin.

Into the brightening pigment-containing orientation paints, additives such as color pigments can be added within the range which does not cause adverse effect on the flip-flop phenomena of the brightening pigments.

As such color pigments, organic pigments such as azo lake series pigments, phthalocyanine series pigments, indigo series pigments, perylene series pigments, quinophthalone series pigments, dioxazine series pigments, quinacridone series pigments, isoindolinone series pigments, metal complex series pigments, etc. can be exemplified. Inorganic pigments such as yellow iron oxide, iron oxide red, titanium dioxide, carbon black, etc. can also be exemplified.

Into the brightening pigment-containing orientation paint, as other components other than the ones described above, additives such as antisettling agents such as polyamide wax which is a lubricous dispersing element of aliphatic series amide, polyethylene wax which is a colloidal dispersion mainly made of oxidized polyethylene, etc.; curing catalysts; ultraviolet absorbers; antioxidants; leveling agents; surface conditioners, such as silicone or organic polymer, etc.; anti-sagging agents; thickeners; antifoaming agents; lubricants; crosslinkable polymer particles which are microgels; can be added if necessary. These additives can be mixed in the amount of 15 parts or less by mass against 100 parts by mass of the vehicle (based on solid content) to improve the properties of above mentioned paints and paint films.

The orientation modifiers can be contained in these paints whether or not the brightening pigment-containing orientation paint is water-based or non water-based one. The orientation modifier can be used in the form of a salt or a neutralized substance. The type of the solvent is not specifically limited so long as the solvent dissolves or disperses the vehicle. For example, organic solvent and/or water can be used as the solvent. As the organic solvent, solvents generally used for various kinds of paints can be exemplified. More specifically hydrocarbons such as toluene, xylene, etc.; ketones such as acetone, methylethyl ketone, etc.; esters such as ethyl acetate, cellosolve acetate, butyl cellosolve, etc.; alcohols can be exemplified. Specifically, in a case where the use of organic solvents is limited from the view point of environmental concerns, water is preferably used. Even in such a case, moderate amount of hydrophilic organic solvent may be used.

The cured orientation paint films of the present invention can be formed by applying the brightening pigment-containing orientation paint on a base material to be coated using a coating, spraying or brushing technique and cured to be a thickness of 5-50 μm.

As the base material, any material having any shape such as exteriors of car bodies made of metal or plastic plates, housings of home appliances such as cell-phone's housings, various types of cases, plastic products, etc. are exemplified.

The cured orientation paint films are used for making the base material such as the exteriors of car bodies, cellphone's housings, etc. into the metallic finish, because the surface being coated is required to have a good design and glittering ornamentation so as to meet market trends and aesthetic preferences of consumers. There observes no unevenness on the cured orientation paint film because the brightening pigment contained in the paint film is homogeneously dispersed. Further the cured orientation paint films are beautiful because the brightening pigment has the flip-flop effect in which the paint film exhibits different colors between when observed from the front and observed from the oblique direction.

The cured orientation paint film, when the thickness of a dried film is made into 5-250 μm, has high F/F value. The F/F value represents a degree of flip-flop effect and is calculated as the difference between L* or brightness in the L* a* b* color system when observed at an acceptance angle of 15° which corresponds to the oblique direction and L* when observed at an acceptance angle of 110° which corresponds to the case observed from the front. The film clearly exhibits a dense, strongly shiny, light-colored white highlight when observed at an angle from the front to the acceptance angle of 15°, however the film exhibits a smoky dark-colored black shade with suppressed luster when observed from an oblique direction.

### DESCRIPTION OF EMBODIMENTS

The orientation modifiers for the brightening pigment of the present invention, and the brightening pigment-containing orientation paints including it were prepared. And the cured orientation paint films of the present invention were produced. Examples 1-3 in which the present orientation modifiers for the brightening pigment prepared, and Comparative Examples 1-2 in which dispersants, which are out of the scope of the present invention, for the brightening pigment, will be specifically explained below.

### EXAMPLE 1

In a flask fitted with a reflux condenser, a thermometer, a stirrer and a dropping funnel, 45.9 g of DIALEN 124 (Registered trade name, Produced by Mitsubishi Chemical Corporation), a mixture of 1-dodecene/1-tetradecene as a-olefin and 28.66 g of maleic anhydride and 35.9 g of xylene were placed. Under a nitrogen gas atmosphere, the mixture was heated to 130° C. with stirring. A mixture of 1.2 g of PERBUTYL O (Trade name, produced by NOF Corporation) and 21.36 g of xylene was added dropwise with stirring over 2 hours. Then, stirring was continued at 130° C. for 1 hour to proceed the reaction. Molecular weight distribution was measured using a gel permeation chromatography (GPC) analyzing equipment, Shodex GPC system (Trade name, produced by Showa Denko K.K.). The analysis showed that an a-olefin/maleic anhydride copolymer having a weight-average molecular weight of 13,000 (i.e. the value converted to polystyrene) was contained in the reaction solution. From the obtained reaction solution, xylene was condensed and removed. Then 256.6 g of BLAUNON SR-715 (Trade name, produced by Aoki Oil Industrial Co., Ltd.) which is a 15 mol adduct of stearyl polyoxyethylene as a polyethylene glycol monoalkyl ether was added. Reaction was carried out at about 160° C. for 2 hours with stirring to produce a modified compound which is an ester compound between a-olefin/maleic anhydride copolymer and polyethylene glycol monoalkyl ether. Its acid value was 32 mg.KOH/g. The reaction mixture of this modified compound was cooled down to a temperature of 100° C. or lower, then diluted to 50% with 3-methyl-3-methoxybutanol to obtain the orientation modifier for the brightening pigment.

### EXAMPLE 2

In a flask fitted with a reflux condenser, a thermometer, a stirrer and a dropping funnel, 45.9 g of DIALEN 124 (Trade mark, produced by Mitsubishi Chemical Corporation) as a-olefin, 28.66 g of maleic anhydride and 35.9 g of toluene were placed. Under a nitrogen gas atmosphere, the mixture was heated to 110° C. with stirring. A mixture of 0.5 g of PERBUTYL L (Trade mark, produced by NOF Corporation) and 21.36 g of toluene was added dropwise with stirring over 2 hours. Then the temperature was maintained at 110° C. with stirring for 4 hours to proceed the reaction. Molecular weight distribution was measured using a gel chromatography (GPC) analyzing equipment, Shodex GPC system (Trade name, produced by Showa Denko K.K.). The analysis showed that an a-olefin/maleic anhydride copolymer with weight-average molecular weight of 25,000 (i.e. the value converted to polystyrene) was contained in the reaction solution. Toluene was condensed and removed from the reaction solution. Then 256.6 g of BLAUNON SR-707 (Trade name, produced by Aoki Oil Industrial Co., Ltd.) which is a 7 mol adduct of stearyl polyoxyethylene as a polyethylene glycol monoalkyl ether was added. Reaction was carried out at about 160° C. for 2 hours with stirring to produce a modified compound which is an ester compound produced between the a-olefin/maleic anhydride copolymer and a polyethylene glycol monoalkyl ether. Its acid value was 55 mg.KOH/g. The thus obtained reaction mixture of this modified compound was cooled down to a temperature of 100° C. or lower and then diluted to 50% with isopropyl alcohol to obtain the orientation modifier for the brightening pigment.

### EXAMPLE 3

In a flask fitted with a reflux condenser, a thermometer, a stirrer and a dropping funnel, 30 g LINEALENE 18 (Trade name, produced by Idemitsu Kosan Co., Ltd.) which is 1-octadecene as a-olefin, 28.66 g of maleic-anhydride and 35.9 g of xylene were placed. Under a nitrogen gas atmosphere, the mixture was heated to 130° C. with stirring. With stirring continued, a mixture of 2 g of PERBUTYL L (Trade name, produced by NOF Corporation), 3 g of V-30 (Trade name, produced by Wako Pure Chemical Industries, Ltd.) which is 1-[(1-cyano-1-methylethyl)azo]formamide as an asymmetric azo polymerization initiator and 21.36 g of xylene was added dropwise over 2 hours. Then the temperature was maintained at 130° C. with stirring for 4 hours to proceed the reaction. Molecular weight distribution was measured using a gel permeation chromatography (GPC) analyzing equipment, Shodex GPC system (Trade name, produced by Showa Denko K.K.). The analysis showed that an a-olefin/maleic anhydride copolymer having a weight average molecular weight of 7,000 (i.e. the value converted to polystyrene) was contained in the reaction solution. Xylene was condensed and removed from the reaction solution. Then 256.6 g of BLAUNON EL-1530 (Trade name, produced by Aoki Oil Industrial Co., Ltd.) which is a 30 mol adduct of lauryl polyoxyethylene as polyethylene glycol monoalkyl ether was added. And reaction was proceeded at about 160° C. for about 2 hours to produce a modified compound which was an ester compound between a-olefin/maleic anhydride copolymer and polyethylene glycol monoalkyl ether. The acid value of the modified compound was 20 mg.KOH/g. The reaction mixture of the modified compound was cooled down to a temperature of 100° C. or lower, and then diluted to 50% with isopropyl alcohol to obtain the orientation modifier for the brightening pigment.

### COMPARATIVE EXAMPLE 1

In a flask fitting with a reflux condenser, a thermometer, a stirrer and a dropping funnel, 45.9 g LINEALENE 10 (Trade name, produced by Idemitsu Kosan Co., Ltd.) which is 1-decene as a-olefin, 28.66 g of maleic anhydride and 35.9 g of xylene were placed. Under nitrogen gas atmosphere, the mixture was heated up to 130° C. with stirring. A mixture of 1 g of PERBUTYL L (Trade name, produced by NOF Corporation) and 21.36 g of xylene was added dropwise over 2 hours. Then the temperature was maintained at 130° C. with stirring to proceed reaction for one hour. Molecular weight distribution was measured using a gel permeation chromatography (GPC) analyzing equipment, Shodex GPC system (Trade name, produced by Showa Denko K.K.). The analysis showed that an a-olefin/maleic anhydride copolymer having a weight average molecular weight of 13,000 (i.e. the value converted to polystyrene) was contained in the reaction solution. Xylene was condensed and removed from the reaction solution. Then 114 g of Methoxy PEG 400 (Trade name, produced by Toho Chemical Industry Co., Ltd.) which is a 9 mol adduct of methoxy polyoxyethylene was added and then heated at about 160° C. for 2 hours with stirring to proceed the reaction, obtaining a modified compound which was an ester compound between a-olefin/maleic anhydride copolymer and polyethylene glycol monomethyl ether. The acid value of the modified compound was 50 mg.OH/g. The reaction mixture of this modified compound was cooled down to a temperature of 100° C. or lower, and diluted to 50% with 3-methyl-3-methoxybutanol to obtain the dispersant.

### COMPARATIVE EXAMPLE 2

In a flask fitted with a reflux condenser, a thermometer, a stirring and a dropping funnel, 45.9 g of LINEALENE 124 (Trade name, produced by Idemitsu Kosan Co., Ltd.) which is a mixture of 1-dodecene and 1-tetradecene as the a-olefin, 28.66 g of maleic anhydride, and 35.9 g of xylene were placed. Under a nitrogen gas atmosphere, the reaction mixture in the flask was heated up to 130° C. with stirring. Next a mixture of 1 g of azobisisobutyronitrile and 21.36 g of xylene was added dropwise over 2 hours. Then the temperature was maintained at 130° C. with stirring for further 1 hour to proceed the reaction. Molecular weight distribution was measured using a gel permeation chromatography (GPC) analyzing equipment, Shodex GPC system (Trade name, produced by Showa Denko K.K.). The analysis showed that an a-olefin/maleic anhydride copolymer having a weight average molecular weight of 13,000 (i.e. the value converted to polystyrene) was contained in the reaction solution. Xylene was condensed and removed from the reaction solution. Then 130 g of Newpole 50HB-100 (Trade name, produced by Sanyo Chemical Industries, Ltd.) which is polyoxyethylene polyoxypropylene butyl ether was added and then stirred at about 160° C. for about 2 hours to proceed the reaction, obtaining the modified compound as an ester compound between a-olefin/maleic anhydride copolymer and polyoxyethylene polyoxypropylene butyl ether. The acid value of the modified compound was 50 mg.KOH/g. The reaction mixture of the modified compound was cooled down to a temperature of 100° C. or lower, and then diluted to 50% with 3-methl-3-methoxybutanol to obtain the dispersant.

Cured orientation paint films were formed from brightening pigment-containing orientation paints of the present invention, which were produced by using the present orientation modifiers for the brightening pigment in Examples 1-3. On the other hand, in Comparative Examples 1 to 2, paint films were formed from paints which were produced by using dispersants and which are inapplicable to the present invention. Orientation properties of these paint films were evaluated.

### (Preparation of Paint and Paint Film)

As a resin, 78.4 g of ACRYDIC A-322 (Trade name, produced by DIC Corporation) an acrylic resin and 22.4 g of SUPER BECKAMINE L-117-60 (Trade name, produced by DIC Corporation) as a butylated melamine resin were stirred at 2,500 rpm for 5 minutes using a disper with a blade whose diameter is 4 cm. After that, 1 g of aluminum flake pigment 7640NS (Trade name, produced by Toyo Aluminium K.K.) and 1 g of each orientation modifier produced in Examples 1-3 or each dispersant produced in Comparative Examples 1-2 were stirred at 2,500 rpm for 2 minutes, obtaining paint stock solutions respectively. The viscosity of each stock solution was adjusted to 500 mPa·s by the addition of a thinner (blend ratio: toluene/n-bufanol/butyl acetate=60/25/15). Each of the thus obtained paints was applied using an applicator for 250 μm, then kept standing still for 20 minutes and then burned at 140° C. for 20 minutes. The film thicknesses were measured using a versatile film thickness meter LZ-200 (Trade name, produced by Kett Electric Laboratory) to be approximately 40 μm.

### (Evaluation of Physical Properties)

L* value at the acceptance angles of 15°, 45° and 110° of each paint film was measured using a multi angle colorimeter MA-68 II (Trade name, produced by X-rite Co.) to evaluate orientation property of the brightening pigment. Results are shown in Table 1.

TABLE 1

| | | | | (L* Value at 15°)- |
|---|---|---|---|---|
| | L* Value | L* Value | L* Value | (L* Value at 110°) |
| | at 15° | at 45° | at 110° | (F/F Value) |
| Ex. 1 | 78.33 | 44.95 | 27.33 | 51.00 |
| Ex. 2 | 78.99 | 45.59 | 27.63 | 51.36 |
| Ex. 3 | 79.71 | 45.24 | 28.49 | 51.22 |
| Comp. Ex. 1 | 74.92 | 47.02 | 33.02 | 41.90 |
| Comp. Ex. 2 | 76.18 | 45.29 | 30.33 | 45.85 |

As is clear from Examples 1-3 in Table 1, in a case where ester compounds, which were obtained by esterification between a-olefin/maleic anhydride copolymer, which was obtained by copolymerizing a-olefin having a carbon number of 6 or more with maleic anhydride, and polyoxyethylene alkyl ether having a terminal hydroxyl group, were used as an orientation modifier for the brightening pigment, the paint films obtained from the brightening pigment-containing orientation paint in which the present orientation modifier was included has a greater F/F value which showed an excellent orientation of the brightening pigment. The F/F value is the difference between L* value at 15° and L* value at 110° and shows an excellent level of the flip-flop property as the orientation property.

The paint film obtained from the paint, which were produced in Comparative Examples 1 and 2 as dispersant corresponding to a conventional acidic dispersant, was used shows F/F values or flip-flop effects far smaller than that of the paint film produced in Examples 1 to 3 in which the orientation modifier was used.

### INDUSTRIAL APPLICABILITY

The orientation modifiers of the present invention for the brightening pigments are added into brightening pigment-containing paints which are used to apply the exteriors of, for example, car bodies, housings, cases, etc. made of metal or plastic. The cured orientation paint films that are obtained from the paints, and that are useful for making the exteriors beautiful because the paint films' color tone are different when the films are observed from different directions, being useful in making these exteriors beautiful.

1. An orientation modifier for a brightening pigment comprising:
an ester compound having an acid value of 15-60 mg.KOH/g, which is esterified between:
an α-olefin/maleic anhydride copolymer copolymerized from a linear or branched α-olefin having at least 6 carbon atoms and a maleic anhydride; and
a polyethylene glycol monoalkyl ether having a hydrophile-lipophile balance of 9-19, which is represented by the following chemical formula (1)
R¹—(OCH₂CH₂)ₙ—OH (1)
(in the formula (1), R¹ is a linear or a branched alkyl group having a carbon number of 6-30, and n is a number of 5-60).

2. A brightening pigment-containing orientation paint comprising:
0.01-5% by weight of the ester compound in the orientation modifier for the brightening pigment according to claim 1, wherein the weight is based on the total weight;
1-50% by weight of the brightening pigment which is dispersed by the orientation modifier; and
10-95% by weight of a vehicle.

3. The brightening pigment-containing orientation paint according to claim 2, wherein the brightening pigment is a flaky pigment of aluminum flake pigment, titanium flake pigment, stainless steel flake pigment, colored aluminum pigment, metal oxide-coated mica pigment, metal oxide-coated silica flake pigment, metal oxide-coated aluminum flake pigment, metal oxide-coated glass flake pigment, plate-like iron oxide pigment and/or a flake-like pigment made of cholesteric liquid crystal polymer.

4. A cured orientation paint film comprising:
the brightening pigment-containing orientation paint according to claim 2, wherein the paint is applied on a base material to be cured.

5. A cured orientation paint film comprising:
the brightening pigment-containing orientation paint according to claim 3, wherein the paint is applied on a base material to be cured.
